(19) United States
(12) Patent Application Publication
(10) Pub. No.: US 2025/0317743 A1
(43) Pub. Date: Oct. 9, 2025

(54) NFC-Enabled Wireless Network and Service Connectivity

(71) Applicant: DISH Network Technologies India Private Limited, Bengaluru (IN)

(72) Inventors: Srinidhi AN, Shivamogga (IN); Sreevastav ANUPURU, Kurnool (IN); Praveen Kumar G, Mangalore (IN)

(21) Appl. No.: 18/778,306

(22) Filed: Jul. 19, 2024

(30) Foreign Application Priority Data
Apr. 8, 2024 (IN) 202441028656

(51) Int. Cl. H04W 12/47; G06Q 10/02; G06Q 50/12; H04W 12/06

(52) U.S. Cl. CPC H04W 12/47; G06Q 10/02; G06Q 50/12; H04W 12/06

(57) ABSTRACT

Arrangements for providing wireless network access and access to hotel services are detailed herein. A reservation management system can be accessed to retrieve a guest reservation. A hotel connectivity system can be used to create wireless network access credentials based on the guest reservation. A near field communication (NFC) tag can be programmed with the wireless network access credentials. The programmed NFC tag, when brought into proximity of a user device, provides the user device with the wireless network access based on the wireless network access credentials obtained wirelessly from the programmed NFC tag.

### CROSS REFERENCE TO RELATED APPLICATIONS

This application claims priority to Indian Provisional Patent Application Ser. No. 20/244,1028656, filed on Apr. 8, 2024, in the Indian Intellectual Property Office, the disclosure of which is incorporated by reference in its entirety for all purposes.

### BACKGROUND

The hospitality industry, especially in hotel accommodations, has witnessed rapid technological advancements aimed at enhancing guest experiences. Despite the technological advancement, the process of checking into hotel rooms and accessing services such as internet connectivity, ordering food, or even simple room customizations remains cumbersome, disjointed, and impersonal.

The prevalent use of quick response (QR) codes for accessing a wireless network (e.g., for internet access), displayed on various in-room devices, has introduced a layer of digital interaction. A user may not be aware of how to access a QR code, have a device with a camera that can scan the QR code, or have an application installed that can read the QR code.

Furthermore, the security measures employed in these systems are often generic, and not tailored to individual users. The same wireless networks (e.g., Wi-Fi networks) and service access points may be utilized by multiple guests, raising significant concerns over data privacy and personal security. The sensitivity of information on wireless networks, coupled with the risk of residue or reuse in networks sharing the same access credentials, leads to additional security risks, compromising guest confidence in their connection's security.

Current approaches may fail to recognize and accommodate guests' known preferences and knowledge, which could be utilized to enhance their experience from the moment they check in. Despite the availability of data from previous stays or through direct guest interactions, there is a noticeable absence of a systematic, personalized response to these insights. This may diminish the potential for creating an immediately welcoming and tailored experience for the guests.

### SUMMARY

Various arrangements are detailed for providing wireless network access. In some embodiments, a method is provided. The method can include accessing, using a reservation management system, a guest reservation. The method can include creating, by a hotel connectivity system, wireless network access credentials based on the guest reservation. The method can include programming, by the hotel connectivity system, a near field communication (NFC) tag with the wireless network access credentials. When the programmed NFC tag is brought into proximity of a user device, the user device may be provided with network access credentials that provide access to a wireless network.

Embodiments of such a method can include one or more of the following features: The NFC tag can be embedded in a keycard used to access a hotel room linked to the guest reservation. The NFC tag can be embedded in a set top box (STB) that outputs television programming to a display device. The wireless network access credentials can be specific to the guest reservation. The wireless network access credentials may remain valid for only a duration of time defined by the guest reservation. The wireless network access credentials can include a user-specific access code. The programmed NFC tag, when brought into proximity of the user device, can further provide access to one or more hotel services customized based on the guest reservation. The one or more hotel services can be selected from the group consisting of: ordering room service, access to on-demand content, and parking. The method can include providing, by the programming NFC tag to the user device, control of one or more smart devices located within a hotel room mapped to the guest reservation.

In some embodiments, a system for providing wireless network access is provided. The system can include a near field communication (NFC) tag and a hotel connectivity system that is configured to be in communication with a reservation management system and a plurality of wireless network access points. The hotel connectivity system can be configured to access a guest reservation using the reservation management system. The hotel connectivity system can be configured to create wireless network access credentials based on the guest reservation. The hotel connectivity system can be configured to program the NFC tag with the wireless network access credentials. When the programmed NFC tag is brought into proximity of a user device, the programmed NFC tag can provide the user device with the wireless network access credentials used to access a wireless network.

Embodiments of such a system can include one or more of the following features: The NFC tag can be embedded in a keycard used to access a hotel room linked to the guest reservation. The system can include a set top box (STB), wherein the NFC tag is embedded in the STB and the STB is configured to output television programming to a display device. The wireless network access credentials may be specific to the guest reservation. The wireless network access credentials can remain valid for only a duration of time defined by the guest reservation. The wireless network access credentials can include a user-specific access code. The programmed NFC tag, when brought into proximity of the user device, can further provide access to one or more hotel services customized based on the guest reservation. The one or more hotel services can be selected from the group consisting of: ordering room service, access to on-demand content, and parking. The programming NFC tag can be configured to provide control of one or more smart devices located within a hotel room mapped to the guest reservation to the user device. The system can include the reservation management system and a plurality of access points (APs) through which the wireless network is accessed using the wireless network access credentials.

In some embodiments, a non-transitory processor-readable medium comprising processor-readable instructions are present. The instructions can cause one or more processors to access a guest reservation using a reservation management system. The instructions can cause one or more processors to create wireless network access credentials based on the guest reservation. The instructions can cause one or more processors to program a near field communication (NFC) tag with the wireless network access credentials, wherein when the programmed NFC tag is brought into proximity of a user device, the user device is provided with network access credentials for a wireless network.

### BRIEF DESCRIPTION OF THE DRAWINGS

A further understanding of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an exemplary overview of a system for providing wireless network access and access to services using one or more NFC tags.

FIG. 2 illustrates an exemplary view of an NFC tag according to embodiments detailed herein.

FIG. 3 illustrates an embodiment of a method for providing wireless network access.

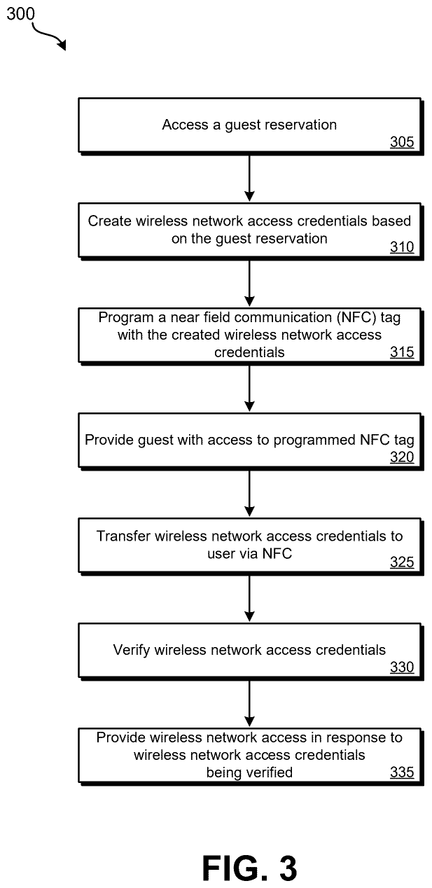

FIG. 4 illustrates an embodiment of a method for loading user preferences via an NFC tag.

FIG. 5 illustrates an exemplary system architecture for NFC Tag Management according to embodiments detailed herein.

### DETAILED DESCRIPTION

As detailed herein, the use of Near Field Communication (NFC) tags can be used to improve the guest experience within hotels or hospitality environments. The disclosed technology provides enhancements to various aspects of the guest interactions or user interactions, enables enhancements to a guest check-in process, enhances security of services within the hotel, and personalizes a hotel room or other environment based on guests' preferences through the strategic use of NFC technology. While this document is focused on providing wireless network credentials and access to services for a hotel, other embodiments can be used in environments other than a hotel. For example, in any environment where a user is to be given customized wireless network credentials, embodiments detailed herein can be used. Examples can include conferences, businesses, guests to an office, visitors to a residential home, shared coworking spaces, airplanes, trains, buses, etc. Further, “hotel” should be understood to include other forms of lodging, including motels, long-term temporary residences, rental homes, apartments, hostels, cruise ships, resorts, etc.

Referring back to the example of a hotel, an NFC tag may be programmed with customized wireless network access credentials. The wireless network access credentials can be programmed based on the NFC tag based at least in part on a reservation of the hotel guest. The wireless network access credentials can be unique to the guest. For example, at least one of a unique service set identifier (SSID), unique passcode, or unique user identifier may be used as part of the wireless network access credentials. The wireless network can be configured such that access is provided to the wireless network only for a time period corresponding to a reservation of the guest at the hotel, thus preventing the network from being used at other times with the same credentials.

The user has access to the programmed NFC tag. In some embodiments, the NFC tag is provided to the user in the user's keycard, which is also used for room access. The NFC tag can also be provided separately, such as with the keycard at check-in or may be installed in the hotel room of the guest. For example, the NFC tag may be incorporated as part of a stationary device or television set top box. The user can bring an NFC-enabled user device (“user device”), which may be a smartphone, into proximity of the NFC tag, such as by tapping it. The user-specific wireless network credentials can then be transferred to the user device and used to access the wireless network. The user-specific wireless network credentials can also be displayed, such as so a user can enter the credentials on non-NFC-enabled devices (e.g., a gaming device without NFC).

The disclosed technology may employ multiple NFC tags to bolster room security. These tags can contain customized information for active NFC tags, including additional configurations for enhanced security measures. For instance, the credentials for wireless network access or room entry can be dynamically set to match the specific needs of the guest, such as linking to the guest's MAC address for a personalized and secure network connection.

The disclosed technology may also use passive NFC tags. In some examples, passive NFC tags may carry non-critical information about the hotel or general services, offering low-cost and low-maintenance solutions for providing guests with essential information. These tags could be stationary or integrated into various parts of the hotel room, facilitating easy access to hotel amenities and information.

An aspect of the disclosed technology includes the ability to selectively activate services based on the data stored on the NFC tag. This enables the personalization of services such as climate control, access to specific content, dietary preferences, and even compliance with local laws regarding alcohol consumption. Furthermore, the system can be configured to restrict or enable certain services based on guest profiles, enhancing the versatility and applicability of the technology across different guest demographics.

The administration of one or more aspects of an NFC-based system can be streamlined through a centralized platform, allowing hotel administrators to program or reprogram NFC tags as needed.

In some examples, the disclosed technology leverages the ubiquity of NFC enabled or NFC capable smartphones to create a user-friendly interface for hotel guests. By simply tapping an NFC tag with their smartphone, guests can connect to the hotel's wireless network without manual password entry, control the hotel's Set-Top Boxes (STBs) using a web-based (or local network based) application or interface, and access a variety of additional functionalities such as screen casting and food ordering.

The implementation of this technology can involve both passive and active NFC tags, which may be pre-programmed by hotel staff or programmatically customized through remote administration for a personalized guest experience. Such an approach not only enhances the guest experience through increased security and personalization but also opens avenues for integrating advanced technologies like Ultra-Wideband (UWB) for further enhancements.

In some examples, the NFC tags employed within this system are designed with multiple sections and layers of security to facilitate the comprehensive suite of features described. These layers ensure that each interaction between the guest and the hotel's services not only remains secure but also highly personalized, enhancing the overall guest experience while maintaining strong privacy and data protection standards.

The NFC tags may also include the ability to be prepopulated with data pertinent to the guest's upcoming stay. This data, which may be derived from the guest's booking information, can include specifics from the user's device used for the booking, personal preferences noted during the reservation process, and any special requests submitted by a guest. By integrating this information into the NFC tag before the guest's arrival, a personalized and streamlined experience from the very first interaction is ensured for a user.

The disclosed technology may simplify both the check-in and check-out processes at a hotel. In some examples (e.g., when an NFC card was provided in advance), guests can bypass traditional front-desk formalities by utilizing their NFC-enabled device or card to immediately access their room and the hotel's network. This instant connectivity not only expedites the entry process but also immediately immerses the guest in a tailored hospitality experience. Similarly, the check-out process is streamlined through NFC technology, enabling guests to review charges, provide feedback, and finalize their stay through a simple tap of their device. This contactless approach not only adds convenience but also aligns with modern expectations for swift and efficient service interactions.

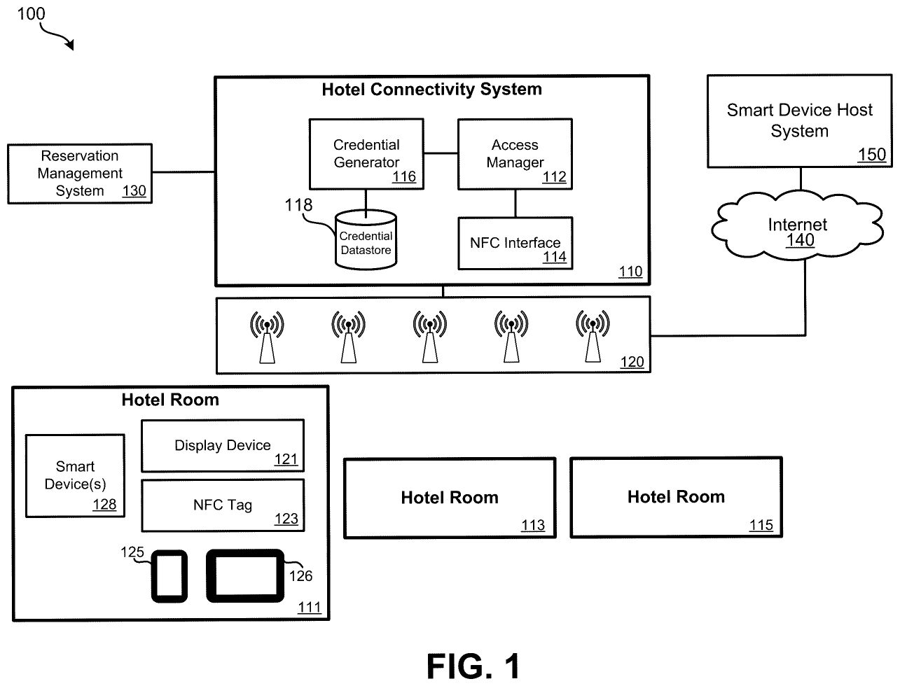

FIG. 1 illustrates an exemplary overview of a system 100 for providing wireless network access and access to services using one or more NFC tags. System 100 can include: hotel connectivity system 110; wireless access points (APs) 120; reservation management system 130; Internet 140; smart device host system 150; smartphone 125; tablet computer 126; display device 121; NFC tag 123; and one or more smart devices 128. System 100 is focused on a system located in a hotel; however, as previously noted, other embodiments can be applied to environments other than a hotel.

Hotel connectivity system 110 can be used to provide, via an NFC tag, data to a user device that enables wireless network access, smart device control, and/or access to hotel services. Data can be retrieved by hotel connectivity system 110 from reservation management system 130 indicative of a user's reservation. Data retrieved from reservation management system can include: a user's name; a user identifier; a user's hotel rewards identifier; a time period of a reservation (e.g., a start date/time and an end date/time); and user preferences (e.g., room temperature, smart device settings, room type preferences, housekeeping preferences, accessibility preferences, streaming service login credentials, etc.).

Components of hotel connectivity system 110 can be implemented using a computing system having one or more processors. Hotel connectivity system 110 may include one or more special-purpose or general-purpose processors. Such special-purpose processors may include processors that are specifically designed to perform the functions of the components detailed herein. Such special-purpose processors may be ASICs or FPGAs which are general-purpose components that are physically and electrically configured to perform the functions detailed herein. Such general-purpose processors may execute special-purpose software that is stored using one or more non-transitory processor-readable mediums, such as random access memory (RAM), flash memory, a hard disk drive (HDD), or a solid state drive (SSD). Further, the functions of the components of hotel connectivity system 110 can be implemented using a cloud-computing platform, which is operated by a separate cloud-service provider that executes code and provides storage for clients.

In response to user input or data from reservation management system 130, access manager 112 may determine to program NFC tag 123 for a user associated with a reservation present in reservation management system 130. Credentials can be created by credential generator 116. The created credentials can include: a service set identifier (SSID), a passcode, and/or a unique user identifier. In some embodiments, a unique SSID and/or passcode is created for each user. In other embodiments, the same SSID and/or passcode is used for each user, but each user is provided a unique user identifier. In some embodiments, a code that permits access to the user's assigned hotel room is loaded onto the NFC tag 123. Credentials can be stored to credential datastore 118. The credentials created by credential generator 116 can be provided to access manager 112, which uses NFC interface 114 to store the credentials onto one or more NFC tags, such as NFC tag 123. NFC interface 114 can write to NFC tag 123, either remotely or when NFC tag 123 is brought into proximity with (e.g., physically touching) NFC interface 114.

NFC tag 123 can be either passive or active. If passive, NFC tag 123 can only output data to be read by a user device. If active, NFC tag 123 can also receive and store data output by the user device. NFC tag 123 can be provided to a user in multiple forms. In some embodiments, upon check-in to the hotel, NFC tag 123 is provided to the user. NFC tag 123 can be attached with or installed in a room keycard, which can also be used to access the room assigned to the user's reservation. In some embodiments, NFC tag 123 may instead be provided with the room keycard, such as part of a portfolio that the user receives upon check-in. In other embodiments, NFC tag 123 may be semi-permanently or permanently attached to a location at check-in, such as to a desk, thus allowing the user to interact with it only while present at the hotel check-in desk.

In other embodiments, NFC tag 123 is located within the user's assigned hotel room 111. For example, NFC tag 123 can be attached with a desk or other surface in hotel room 111. Data can be written to NFC tag 123 within hotel room 111 via a wireless network formed by APs 120 or by another device. As an example, NFC tag 123 can be incorporated as part of display device 121 or a STB. Display device 121 or an STB can receive data via a wireless or wired network from hotel connectivity system 110 and program NFC tag 123.

In some embodiments, multiple NFC tags may be present. For example, an NFC tag 123 can be provided to a user and can also be semi-permanently or permanently attached in hotel room 111. Illustrated in FIG. 1 additional hotel rooms 113 and 115. At least some other hotel rooms may be similarly equipped with NFC tags like hotel room 111. In some embodiments, different NFC tags can be used for different services. For example, a first NFC tag can be used for wireless network access. As detailed herein, a second NFC tag can be used for accessing an application or webpage through which smart devices in the hotel room can be controlled. A third NFC tag can be used for accessing an application or webpage through which hotel services can be requested or ordered.

APs 120 can form a wireless network and be located within or in proximity to hotel rooms 111, 113, and 115. The wireless network can be a Wi-Fi network, a network that operates in accordance with the IEEE 802.11 family of standards, or some other form of wireless local area network (WLAN). In order to access Internet 140 and, possibly, various services hosted by the hotel, a user may provide appropriate access credentials to APs 120. Traditionally, a user is provided on paper an SSID and a passcode. In contrast, in embodiments detailed herein, a user's device, such as smartphone 125, may be connected with the wireless network formed by APs 120 in response to communicating with NFC tag 123. A user may touch, tap, or at least move NFC tag 123 into proximity with smartphone 125. The wireless network credentials that were loaded onto NFC tag 123 can be used by smartphone 125 to attempt to access the wireless network formed by APs 120.

As previously detailed, at least one portion of the wireless network credentials created by credential generator 116 is specific to only the user and the user's reservation. These credentials can be stored to credential datastore 118 and can be accessed or provided to APs 120. When the wireless network credentials are used to access the wireless network, access to the wireless network can be granted or denied based on whether the wireless network credentials are valid in credential datastore 118. For example, a user specific identifier or passcode can be checked to ensure it is present in credential datastore 118. In some embodiments, it may also be confirmed whether the current time falls within a valid time period mapped to the wireless credentials from the user's reservation retrieved from reservation management system 130. Various parameters may also be configured based on data present in credential datastore 118 (which may have been retrieved from reservation management system 130). For example, if a user is part of a hotel rewards program or has paid a premium, the user may be provided with higher speed access to Internet 140 than if the user is not part of the hotel rewards program.

In some embodiments, when a user brings smartphone 125 into proximity of NFC tag 123, a connection to the wireless network formed by APs 120 is caused to be performed automatically. In some embodiments, the user may be prompted to confirm that connection to the wireless network is desired. In some embodiments, the SSID, passcode, and/or user specific identifier may be displayed by smartphone 125. While the examiner of FIG. 1 indicates that a smartphone is brought into proximity with NFC tag 123, any form of NFC-enabled device that is to be connected to the wireless network can be used. For example, an NFC-enabled tablet computer, NFC-enabled laptop, and NFC-enabled gaming device, etc. are other possible options. As shown in FIG. 1, a user has also brought tablet computer 126. If NFC-enabled, tablet computer 126 can be brought into proximity of NFC tag 123. If not NFC-enabled or NFC tag 123 is inconvenient, the user may have the ability to retrieve the wireless network credentials from smartphone 125 and manually enter.

Additionally or alternatively, NFC-enabled access to hotel amenities, such as spa services, dining reservations, and activity bookings, can be provided. The NFC tag used may be the same or a different NFC tag from NFC tag 123. When an NFC-enabled device, such as smartphone 125, is brought into proximity of the NFC tag, additional data may be provided to smartphone 125 that allows for access to hotel services. For example, a link to an application may be provided that can be loaded on smartphone 125. Alternatively, a link to a webpage may be provided through which such services can be accessed or requested.

Additionally or alternatively, NFC-enabled access to control one or more smart devices 128 can be provided via an NFC tag. The NFC tag may be the same or a different NFC tag from NFC tag 123. Various one or more smart devices 128 can be located in hotel room 111, such as a smart thermostat (which can be turned on/off, have a mode set, and have the temperature setpoint changed remotely), smart lights (which can be turned on/off and, possibly, dimmed remotely), smart televisions (e.g., which can be turned on/off and controlled remotely), a smart speaker, etc. When smartphone 125 or another NFC-enabled device is brought into proximity with NFC tag 123, a link to an application or a link to a webpage can be loaded from NFC tag 123 that enables control of such one or more smart devices 128. In some embodiments, stored preferences on smartphone 125 can be used to immediately configure one or more smart devices 128 in accordance with the user's preferences. For example, a preferred setpoint temperature can be used to control a smart thermostat. As another example, streaming service login credentials can be loaded on a smart television. If a webpage (or application) configured particular to hotel room 111 is loaded, a user can use the webpage to control the present one or more smart devices 128. In some embodiments, the smart devices may be controlled via smart device host system 150, which can be operated by a manufacturer of one or more smart devices 128. When a change to a smart device of one or more smart devices 128 is desired, the webpage or application with which the user is interacting can send a command via Internet 140 to smart device host system 150, which can then send an authorized command to the smart device located in hotel room 111.

In some examples, display device 121 within the room can be a smart TV, enhancing the entertainment system with advanced capabilities. Upon tapping NFC tag 123, user preferences can trigger specific actions, such as displaying a unique code on display device 121 for additional verification or access to personalized content. Furthermore, NFC tag 123 can convey preferences to display device 121 (or an STB connected with display device 121) enabling functions like setting an alarm, choosing preferred channels, or even adjusting viewing settings, based on the preferences stored within the NFC tag. This integration ensures that the in-room entertainment system not only offers a wide range of viewing options but also adapts to the guest's personalized requirements, enhancing the overall user experience.

Passive NFC tags, strategically placed throughout the hotel room, including on dining tables and alongside informational brochures, serve as gateways to a wide array of services and information. By tapping their NFC-enabled devices against these tags, guests can instantly access room service menus, make dining reservations, explore local attractions, and even receive personalized recommendations based on their preferences. This simple interaction mechanism enhances the guest experience by making information and services readily accessible, eliminating the need for physical menus or guidebooks, and fostering a more connected and interactive stay.

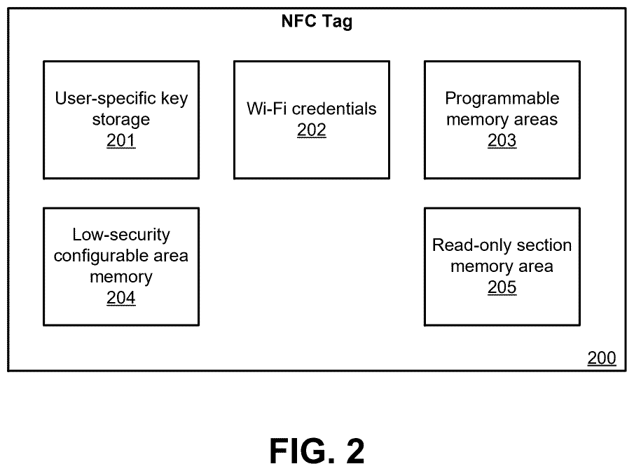

FIG. 2 illustrates an exemplary view of an NFC tag according to embodiments detailed herein. FIG. 2 depicts an NFC tag or NFC device, denoted as NFC tag 200, which comprises several discrete components designed to enable a range of functionalities and security measures within the hotel's smart infrastructure, thereby facilitating enhanced guest experiences.

NFC tag 200 represents a compact and programmable device endowed with NFC capabilities, thereby enabling wireless communication with NFC-enabled devices such as smartphones. The NFC tag is adaptable to various form factors, including stickers, cards, or embedded chips, to allow versatility in deployment across diverse applications and form factors. The NFC tag can incorporate various types of memory to accommodate diverse data storage requirements. Common memory configurations include Read-Only Memory (ROM), which stores immutable data such as device identifiers or manufacturer information. Additionally, the NFC tag may incorporate Electrically Erasable Programmable Read-Only Memory (EEPROM) or flash memory, enabling read and write operations to facilitate dynamic data storage, configuration settings, or user-specific preferences. This flexible memory architecture empowers the NFC tag to adapt to a multitude of applications and use cases within the hospitality context, ranging from guest authentication to personalized service provisioning, thereby enhancing the overall guest experience.

User-specific key storage 201 may be a segment of the NFC tag which may be specifically allocated for the storage of unique cryptographic keys, with each key being uniquely or semi-uniquely assigned to individual users. The encryption and secure storage of these keys within the NFC tag serve to bolster security and authentication processes, thereby facilitating personalized interactions and access control. By restricting access to authorized users exclusively, this feature ensures the safeguarding of specific functionalities or services.

Wireless network credentials 202 may be stored in a portion of the NFC tag that is dedicated to the storage of such credentials, thereby enabling guests to seamlessly connect their devices to the hotel's wireless network. Through the act of tapping their NFC-enabled device on the tag, guests can effortlessly retrieve, thereby obviating the need for manual configuration, and enhancing user convenience and satisfaction.

Programmable memory areas 203 within NFC tag 200 may encompass programmable areas that can be tailored to accommodate diverse functionalities and configurations, thereby catering to specific requirements or preferences. Hotel administrators possess the prerogative to leverage these programmable areas for the purpose of adjusting settings, parameters, or permissions, thereby facilitating adaptable responses to evolving guest preferences or operational exigencies.

Low-security configurable area memory 204 of NFC tag 200 may be a designated section of the NFC tag which serves as a configurable zone characterized by lower security constraints. Low-security configurable area memory 204 of NFC tag 200 provides hotel management the flexibility to modify settings or configurations without compromising sensitive data or critical functionalities. By harnessing this area, hotel administrators can tailor the guest experience, customize service options, or refine room preferences in alignment with individual guest requirements, thereby enhancing overall guest satisfaction and engagement.

Read-only section memory area 205 of NFC tag 200 incorporates a read-only segment housing immutable information or data pertinent to essential aspects such as billing, reservations, or service charges. The inclusion of this section ensures the integrity of data and mitigates the risk of unauthorized modifications, thereby furnishing a reliable source of information for both guests and hotel staff alike.

Various methods can be performed using the systems and arrangements of FIG. 1 and/or FIG. 2. Method 300 can be performed using system 100 of FIG. 1. While the detailed embodiment of method 300 focuses on use at a hotel, other embodiments can be used in situations other than a hotel. At block 305, a guest's reservation can be retrieved. For example, during check-in, a reservation management system can be accessed and a reservation of the user can be retrieved. Information about the user and the user's stay (e.g., a time period) can be retrieved.

At block 310, a hotel connectivity system can generate a unique digital profile for the guest, incorporating reservation details, room assignments, and any special requests or preferences specified during the booking process. This digital profile serves as the foundation for customizing the guest's NFC tag and personalizing their in-room experience. As part of block 310, customized wireless network access credentials can be created, which can include: a unique SSID, a unique passcode, and/or a unique user identifier or unique user passcode. The customized wireless network access credentials can be stored and access to such credentials provided to the wireless network such that, when the credentials are used, APs of the wireless network can determine whether access should be permitted or denied. If the NFC tag is already in the user's room, the NFC tag may be programmed remotely, such as via a wireless network or via another device located in the hotel room, such as an STB that receives data via the wireless network and then communicates with the NFC tag.

At block 315, an NFC tag, which can be active or passive, is programmed based on block 310. The NFC tag may be located in the room associated with the user's reservation or may be held at the front desk in order to present to the user at check-in. At block 320, the user can be given the NFC tag, such as at check-in. Alternatively, the user may just find or be told of the NFC tag being present in the user's room or another predefined location. The user can also be given access to other NFC tags, each of which may direct the user to a different application or webpage, such as a webpage to access/request hotel services or a webpage to control in-room smart devices. (These NFC tags may be static for a given hotel room, or may be updated to provide a unique link for each hotel room reservation, such as to prevent a former visitor to a hotel from altering the state of smart devices in the room in which they are not staying.)

At block 325, in response to an NFC-enabled device, such as a user's smartphone, being brought into proximity of the NFC tag, data is transmitted to the NFC-enabled device. This data can include the customized wireless network access credentials, which can then either automatically or, in response to user authorization, be used by the NFC-enabled device to access a wireless network formed by one or more APs. The NFC-enabled device can also present the credentials for manual entry onto a non-NFC enabled device (e.g., a gaming device).

At block 330, in response to the NFC-enabled device attempting to connect with the wireless network using the customized wireless network access credentials, the wireless network (e.g., an AP of the wireless network) can verify the customized wireless network access credentials either using stored data or by accessing a credential datastore. Access to at least some features of the wireless network (e.g., access to the Internet, streaming services) are provided at block 335 in response to the customized wireless network access credentials being authenticated. The NFC-enabled device's MAC address may be at least temporarily stored to permit continued access to the wireless network for the duration of the user's reservation.

Upon the guest's check-out or in response to the time period of the stored reservation lapsing, the NFC tag is deactivated or cleared to remove access privileges and personalization settings associated with the departing guest. This step ensures data security and privacy by preventing unauthorized access or use of the NFC tag after the guest's departure. The NFC tag can then be prepared for reprogramming or reassignment to the next guest, completing the cycle of guest interactions and ensuring readiness for the next check-in. This step may involve resetting the NFC tag's memory, updating firmware or configurations, and verifying its functionality for future use.

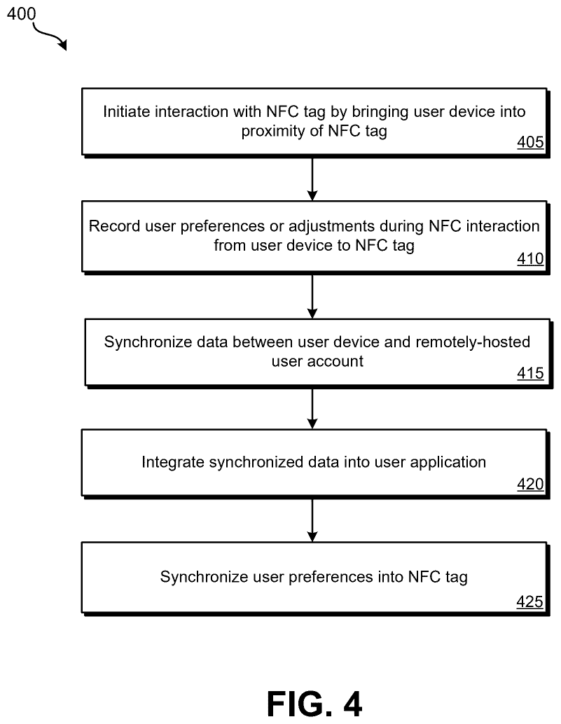

FIG. 4 illustrates an embodiment of a method 400 for loading user preferences via an NFC tag. At block 405, a guest is provisioned with an NFC tag, typically embedded in a keycard, embedded in an STB, or provided as a standalone device. The NFC tag may contain programmable memory, such as EEPROM (Electrically Erasable Programmable Read-Only Memory), storing encrypted data related to the guest's room reservation and access privileges. Hotel staff can program these tags remotely using a central management system, ensuring seamless integration with the guest's digital profile.

At block 410, the guest obtains an NFC-capable smart device, such as a smartphone or tablet, equipped with NFC communication capabilities. These devices feature an NFC antenna and chipset, enabling short-range wireless communication with NFC tags. Additionally, the device may support NFC protocols such as ISO/IEC 14443 and ISO/IEC 18092, facilitating interoperability with various NFC-enabled systems.

At block 415, an interaction is initiated between the smartphone and the NFC tag through electromagnetic induction. When the guest brings their smartphone close to the NFC tag, the NFC antenna in the device generates a magnetic field, inducing a current in the tag's antenna. This interaction powers the NFC tag and enables bidirectional communication between the devices.

At block 420, the NFC tag detects the smartphone's signal and establishes communication using Near Field Communication (NFC) protocols. The NFC tag contains an NFC controller responsible for managing communication with external devices. Upon detecting the smartphone's NFC signal, the tag's controller activates and initializes communication protocols, preparing to exchange data with the smartphone.

At block 425, the NFC tag transmits WLAN network information to the smartphone using NFC Data Exchange Format (NDEF) messages. The NDEF message contains records specifying the network name (SSID) and password (PSK) required for connection. These records are encrypted to ensure data integrity and confidentiality during transmission.

At block 430, the smartphone (or other device) automatically connects to the hotel's WLAN network using the received information. Upon receiving the NDEF message containing WLAN credentials, the smartphone's operating system processes the data and initiates a connection request to the designated network. The device utilizes the provided SSID and PSK to authenticate and establish a secure wireless network connection, enabling internet access for the guest.

At block 435, the guest's device successfully establishes a secure WLAN connection, allowing seamless internet access for browsing, streaming, and other online activities. The device dynamically adjusts network settings, including IP address assignment and DNS configuration, to ensure optimal connectivity within the hotel's network environment.

At block 440, additional actions can be triggered based on predefined rules or user preferences. For example, the NFC tag may initiate a web browser session on the smartphone, directing the guest to a customized portal for accessing hotel services or amenities. Alternatively, the tag could trigger the display of a QR code containing additional information or promotional offers, enhancing the guest's overall experience. These supplementary actions leverage the versatility of NFC technology to streamline guest interactions and provide personalized services within the hospitality environment.

FIG. 4 illustrates an embodiment of a method 400 for loading user preferences via an NFC tag. At block 405, a guest initiates an interaction with the NFC tag by tapping or bringing into proximity his or her NFC-enabled device or NFC card on the designated NFC tag location within the hotel room. This action serves as the starting point for personalizing the guest experience and gaining control over various aspects of the room environment.

At block 410, the NFC tag records the user's preferences and adjustments made during the interaction of block 405. This includes capturing details such as desired room temperature settings, preferred lighting settings (e.g., on/off, dimmer settings), or any other environmental modifications chosen by the guest. In some embodiments, a thermostat may have integrated NFC capabilities. Moving the guest's NFC tag into proximity of the NFC-enabled thermostat can cause a desired temperature setpoint, thermostat settings, or a thermostat schedule from the NFC tag to be provided to the thermostat. The thermostat may then use the transferred information to control HVAC functionality within the room.

At block 415, recorded data is synchronized with the guest's mobile device or online account. This synchronization ensures that the personalized preferences are readily accessible and securely stored for future use, regardless of the guest's preferred platform for managing their settings. For example, the data may have included lowering the temperature of the room through the thermostat, or dimming the lights to a certain temperature. The user need not tap the NFC tag specifically for this synchronization. This may occur whenever a user taps his or her NFC enabled device or room key on one or more NFC enabled devices in the room, which may be synchronized with one another.

At block 420, the synchronized data can be integrated into the functionality of the devices within the hotel room. This integration provides guests with a convenient and centralized platform to access and manage their personalized settings and preferences, enhancing their overall experience during their stay. A user may review the updated data on the application, and indicate which of the preferences he or she wishes to make permanent or part of his or her user profile.

With the personalized preferences now loaded to the hotel room's devices, the process may proceed to block 425, where the updated settings are configured onto the NFC tag itself. This configuration process consolidates all personalized data onto the NFC-enabled device, allowing guests to access and manage their preferences directly from their NFC-tagged device. This can occur at any point in time when the user taps his or her NFC enabled device onto an NFC tag (e.g., a hotel key containing an NFC tag). As part of block 425, when the hotel room is configured in the user's desired state (e.g., after the user has modified certain aspects, such as the temperature setpoint or input streaming credentials), the user can initiate a process which transfers the preferences to the user's NFC-enabled device for future retrieval.

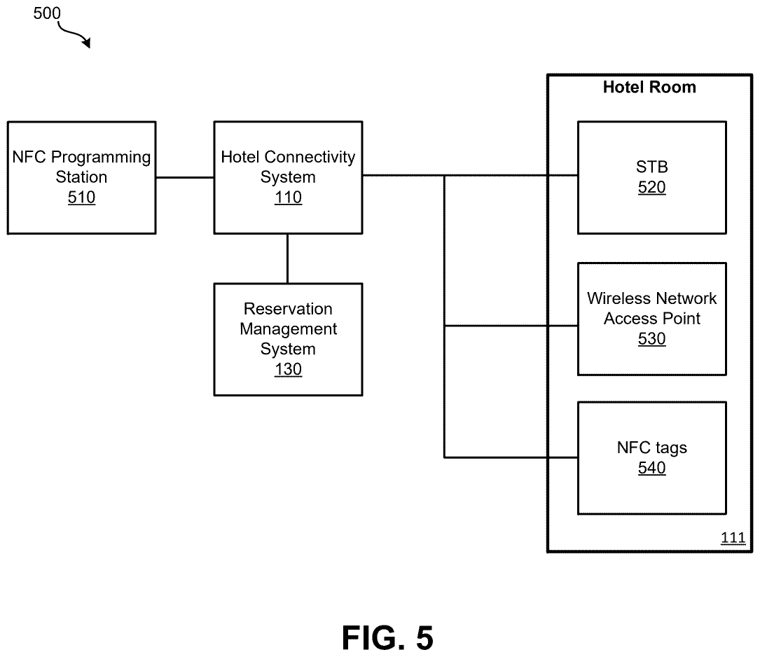

FIG. 5 illustrates an exemplary system architecture 500 for NFC Tag Management according to embodiments detailed herein. Architecture 500 manages and leverages NFC technology within a hotel environment, enabling seamless guest interactions and personalized experiences. At the center of this architecture is the management system 501, which may be a centralized control hub that orchestrates the programming and administration of NFC tags deployed throughout the premises. The management system 501 may contain capabilities of receiving reservations, communicating with back-end systems and reservation systems, and be hardwired or otherwise in data communication with other devices on a hotel premises to allow for communication. As illustrated in FIG. 5, in one example, the management system 501 may control various devices within one room 502 (e.g., STB 520, a Wi-Fi access point 530, and one or more NFC tags 540 (or NFC compatible devices) which are physically within the room).

Key components within architecture 500 include the NFC programming station 510, which serves as a dedicated workspace equipped with RFID readers, NFC writers, and software interfaces for programming NFC tags or NFC compatible devices (e.g., a set top box, smart device, or other device). Hotel staff may utilize this station to encode NFC tags with guest-specific information, access credentials, and service configurations, ensuring a tailored and efficient guest experience. This may be done automatically based on a booking or other system from which information is received regarding guests. NFC programming station 510 can be integrated as part of NFC interface 114 of FIG. 1.

STB 520 acts as a central hub for in-room entertainment and guest interactions. Integrated with the management system 501, the STB 520 facilitates communication and data exchange with NFC-tagged devices, enhancing the functionality and interactivity of guest experiences. Additionally, the Wi-Fi access point 530 may integrate with the management system 501 to enable automatic provisioning of Wi-Fi credentials to NFC tags. This allows guests to connect their devices to the hotel network upon arrival without manual configuration.

NFC tags 540 may serve as physical touchpoints for guest interactions. Each NFC tag may be uniquely identified and programmed with guest-specific information, preferences, and access permissions, facilitating seamless access to services, amenities, and personalized experiences. Moreover, architecture 500 may include other devices and systems such as door locks, room controls, and service kiosks, accessible via NFC tags, enabling guests to interact with various hotel facilities and services using their NFC-enabled devices.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

1. A method for providing wireless network access, comprising:
accessing, using a reservation management system, a guest reservation;
creating, by a hotel connectivity system, wireless network access credentials based on the guest reservation; and
programming, by the hotel connectivity system, a near field communication (NFC) tag embedded in a keycard with the wireless network access credentials, wherein
the keycard is used to access a hotel room linked to the guest reservation; and
when the keycard comprising the programmed NFC tag is brought into proximity of a user device, the user device is provided with the wireless network access credentials from the embedded NFC tag that provide access to a wireless network.

2. (canceled)

3. The method for providing the wireless network access of claim 1, wherein the NFC tag is embedded in a set top box (STB) that outputs television programming to a display device.

4. The method for providing the wireless network access of claim 1, wherein the wireless network access credentials are specific to the guest reservation.

5. The method for providing the wireless network access of claim 1, wherein the wireless network access credentials remain valid for only a duration of time defined by the guest reservation.

6. The method for providing the wireless network access of claim 1, wherein the wireless network access credentials comprise a user-specific access code.

7. The method for providing the wireless network access of claim 1, wherein the programmed NFC tag, when brought into proximity of the user device, further provides access to one or more hotel services customized based on the guest reservation.

8. The method for providing the wireless network access of claim 7, wherein the one or more hotel services are selected from the group consisting of: ordering room service, access to on-demand content, and parking.

9. The method for providing the wireless network access of claim 1, further comprising:
providing, by the programming NFC tag to the user device, control of one or more smart devices located within the hotel room mapped to the guest reservation.

10. A system for providing wireless network access, comprising:
a keycard used to access a hotel room linked to a guest reservation;
a near field communication (NFC) tag embedded in the keycard;
a hotel connectivity system that is configured to be in communication with a reservation management system and a plurality of wireless network access points, wherein the hotel connectivity system comprises one or more processors and is configured to:
access the guest reservation using the reservation management system;
create wireless network access credentials based on the guest reservation; and
program the NFC tag with the wireless network access credentials, wherein when the keycard comprising the programmed NFC tag is brought into proximity of a user device, the programmed NFC tag provides the user device with the wireless network access credentials used to access a wireless network.

11. (canceled)

12. The system for providing the wireless network access of claim 10, further comprising a set top box (STB), wherein the NFC tag is embedded in the STB and the STB is configured to output television programming to a display device.

13. The system for providing the wireless network access of claim 10, wherein the wireless network access credentials are specific to the guest reservation.

14. The system for providing the wireless network access of claim 13, wherein the wireless network access credentials remain valid for only a duration of time defined by the guest reservation.

15. The system for providing the wireless network access of claim 10, wherein the wireless network access credentials comprise a user-specific access code.

16. The system for providing the wireless network access of claim 10, wherein the programmed NFC tag, when brought into proximity of the user device, further provides access to one or more hotel services customized based on the guest reservation.

17. The system for providing the wireless network access of claim 16, wherein the one or more hotel services are selected from the group consisting of: ordering room service, access to on-demand content, and parking.

18. The system for providing the wireless network access of claim 10, wherein the programming NFC tag is configured to provide control of one or more smart devices located within the hotel room mapped to the guest reservation to the user device.

19. The system for providing the wireless network access of claim 10, further comprising the reservation management system and a plurality of access points (APs) through which the wireless network is accessed using the wireless network access credentials.

20. A non-transitory processor-readable medium comprising processor-readable instructions configured to cause one or more processors to:
access a guest reservation using a reservation management system;
create wireless network access credentials based on the guest reservation; and
program a near field communication (NFC) tag embedded on a keycard with the wireless network access credentials, wherein when the keycard comprising the programmed NFC tag is brought into proximity of a user device, the user device is provided with network access credentials for a wireless network.
